(19) United States
(12) Patent Application Publication
(10) Pub. No.: US 2018/0015389 A1
(43) Pub. Date: Jan. 18, 2018

(54) CHROMATOGRAPHY COLUMNS AND THEIR OPERATION

(71) Applicant: Biotechflow Ltd, Stroud (GB)

(72) Inventor: Martin John Hofmann, Stroud (GB)

(73) Assignee: Biotechflow Ltd, Stroud (GB)

(21) Appl. No.: 15/716,912

(22) Filed: Sep. 27, 2017

Related U.S. Application Data
(63) Continuation of application No. PCT/GB2016/050862, filed on Mar. 24, 2016.

(30) Foreign Application Priority Data
Mar. 27, 2015 (GB) 1505359.8

(51) Int. Cl. B01D 15/22; G01C 9/06

(52) U.S. Cl. CPC B01D 15/22; G01C 9/06

(57) ABSTRACT

A chromatography column comprises a 2-axis inclinometer for determining or monitoring the orientation the axial verticality of the column tube or of a column component such as a piston. A column inclinometer may be mounted on the column. A piston inclinometer may be mounted on the piston. Outputs from the inclinometer may be fed to a programmable logic controller and used to control the operation of the column, e.g. by adjusting a support stand of the column, or controlling a piston drive mechanism.

### CROSS-REFERENCE TO RELATED APPLICATIONS

This application is a continuation of International Application No. PCT/GB2016/050862 filed Mar. 24, 2016, which claims the benefit of United Kingdom Application No. 1505359.8 filed Mar. 27, 2015, which are hereby incorporated by reference.

### BACKGROUND

This invention has to do with chromatography columns, and methods of installing and operating chromatography columns. It has particular relevance to large-size chromatography columns such as are used for industrial-scale production of e.g. pharmaceuticals and the like. However, the ideas proposed herein may be applied in various kinds of chromatography columns or similar separation apparatus using a column tube.

In general, a chromatography column has a column tube which is axially upright, that is to say, the axis of the column tube is vertical. A bed of chromatography medium, usually solid particles, is established in the interior space or operating volume of the column tube. The tube is provided with top and bottom closures or end cells to retain the medium and process fluids and to isolate the interior from external contamination.

The nature of the top and bottom column closures, and the manner of mounting or support of the column, depends on the type of column and type of process. Many industrial-scale chromatographic production processes use packed bed columns, in which a bed of particles lies on a permeable retaining surface—usually a mesh—at the bottom of the column. The mesh is supported over a base plate with clearance allowing liquid to flow to or from a fluid conduit communicating through the base plate. At the top, the column may be provided with a piston closure which can fit down sealingly inside the column tube wall to lie on top of the particle bed, and—like the base—has a permeable element such as a mesh overlying a fluid conduit communicating through the piston. The top and bottom fluid conduits are usually central, i.e. on the axis of the column which is usually cylindrical. Where there is a piston it is usually supported by a central support rod or by a set of circumferentially-distributed support rods, connected to a support ring or other raised structure above the level of the column tube, so that it can be raised and lowered either for compacting down on top of the bed, or for filling, emptying or cleaning the column, or for other reasons. Additionally or alternatively some columns have a piston at the bottom end i.e. as a movable base plate. Packed bed columns may be a metre or more, even two metres or more in diameter. Because they hold a large volume of liquid which is usually substantially raised in pressure during the process, they must be very strong and their components tend to be very heavy, and difficult to manoeuvre and control.

Simpler columns may be made with a fixed closure member rather than a sliding piston at the top and/or bottom. Columns of different sizes and proportions are used for different processes such as ion exchange, affinity and size exclusion chromatography, including and expanded bed adsorption processes (EBA).

In expanded bed separation processes a bed of particles operates under an upflow of liquid sufficient to suspend the particles separately from one another while the material to be separated is passed up through the fluidised bed. The fluidised particle bed does not always completely fill the column; a liquid-only (supernatant) volume is maintained at the top and liquid is removed continually through an outlet at the top. In some expanded bed processes a top piston or cover is provided to enclose the supernatant volume leading to the outlet. Expanded bed columns are often taller than packed columns and this introduces characterising set-up and handling difficulties, for example if and when it is necessary to remove or manoeuvre a top cover or piston.

While chromatography columns as described are often large and heavy apparatus they are also very sensitive to operating conditions. Great efforts must be made to ensure accurate and uniform packing of particle beds, and uniform and stable fluidisation of expanded beds. Unwanted voids or other non-uniformities can ruin the separation process or radically reduce its yield, and the product is usually of very high value. Thus it is strongly desired to avoid any non-uniformity or misalignment of the particle bed, such as variations in bed density. Among other precautions, it is known to be necessary to adjust for levelness of the column and for perpendicularity of the bed, especially at the larger scale. This is normally done by means of adjustable supports—such as legs with screw-threaded, hydraulic or pneumatic adjusters—used in conjunction with portable spirit levels to check the alignment of the column.

### SUMMARY

The inventor has noted that various aspects of chromatography processing, including the practical convenience of installation and operation, the effectiveness of separation, and the maintenance of reliable operation, could be significantly enhanced by enabling certain improvements in the set-up of columns.

In a first aspect, the invention provides a chromatography column comprising or incorporating an inclinometer for measuring the orientation of the column, or of one or more components thereof, relative to the horizontal and/or vertical. The inclinometer is generally operable to produce an output signal representative of inclination or orientation of the column or column component relative to the acceleration of gravity. There may be more than one inclinometer, and the functions of first and second inclinometers may complement or cooperate with one another.

The inclinometer is desirably fixedly mounted to the column. The column may comprise a flat reference surface, e.g. a surface normal to the column's axial direction, e.g. lying in a radial/horizontal plane, or normal to a radial direction thereof e.g. lying in a vertical/axial plane, on which or against which the inclinometer is fixed or can be fixed.

The inclinometer is typically an electronic or electric device producing an output signal representative of inclination or orientation of the column/component relative to the acceleration of gravity. The signal may be output to a display and/or to a control processor. The control processor may be programmed to operate an adjustable support structure for the column/component to adjust its orientation in dependence on the output signal from the inclinometer, as described further below, or to indicate the adjustment needed and/or how to make such adjustment, to give an alarm or warning in the event of a change of the detected inclination, or in the event that the detected inclination exceeds a predetermined deviation from the horizontal, to record or log the orientation over a period for monitoring or process validation reasons, or any combination of these or other functions.

The inclinometer is preferably a two-axis inclinometer disposed to measure the orientation or inclination of the column or component thereof relative to the horizontal in mutually transverse or perpendicular axes, so that the column or component can be fully levelled relative to a horizontal plane based on the resulting information. Of course, plural single-axis inclinometers aligned mutually transversely or perpendicularly may be used instead.

Information about the absolute orientation of a separation column or column component relative to the horizontal/vertical can be useful in various ways.

A column tube is usually a fundamental column component. Thus, an inclinometer can be used to indicate whether a column tube of the column is level, that is to say axially vertical. For this purpose an inclinometer may be fixed or mounted on the column tube itself, e.g. on a sidewall thereof, or on an end flange of the tube, or it may be mounted on a fixed end member of the column such as a top closure e.g. a top plate or cap, or a bottom closure or bottom plate, such as a base plate. Alternatively a mounting piece for mounting the inclinometer may be fixed to any of these components or portions, e.g. by welding or by threaded fasteners. Any of these components or portions may be provided with a reference mounting such as a flat reference surface, preferably a surface normal to the column axis, against which an inclinometer device can be fixed. The reference mounting may include mounting means such as fasteners, or formations such as threaded holes for receiving fasteners, to mount the inclinometer(s).

A support structure for the column is preferably a stand having a set of support feet to make respective support contacts distributed around the column to support it stably on a support surface, usually a floor. The feet may be on respective legs. The support structure/stand desirably incorporates levelling adjustment mechanism for adjusting the angular alignment or orientation of the column tube axis relative to the support structure or support surface by adjusting the relative axial positions of respective support contacts, such as spaced support feet. The levelling adjustment mechanism may be provided as respective mechanisms for all or some of the support feet for adjusting their axial distance from the column tube (height), typically by adjusting the length of legs. Any suitable adjusting mechanism may be used and several are known; they may be adjusted by mechanical means, such as screw-threaded adjusters which may be power drivable and/or manually-operable, by hydraulic means or by pneumatic means. A power drive for such a mechanism may comprise e.g. a servo motor, stepper motor, linear motor, hydraulic or pneumatic drive which can be driven progressively to a controlled extent, and preferably with feedback or detection of position, because these are suitable for automation of the levelling control. The support feet/legs/drive mechanisms may have releasable locks operable to lock them at a given axial position reached by adjustment. Desirably at least some of the support contact adjusting mechanisms are connected for individual control by a control processor connected to an inclinometer as described herein.

As is known, and especially for larger columns, transfer supports adapted for moving the column horizontally (such as supports comprising rollers or wheels) may optionally be provided separately from or additional to the adjustable support contacts of the support structure mentioned above which are desirably non-rolling fixed feet. For example the transfer supports may be removable or retractable, and/or the support structure may be advanceable to take over support from the transfer supports.

As mentioned, the inclinometer output may be connected to a control processor or other data processor for controlling or assisting control of the operation of the column or column component, with respect to its orientation, in any manner suggested herein. In particular, the inclinometer output signal may be supplied to a control or other data processor such as any one or more of a programmable logic controller (PLC), personal computer (PC), human-machine interface (HMI), data logger, display or the like. Communication of the inclinometer output to the processor may be e.g. via cable or by wireless signal.

The skilled person knows technical communication protocols and technology bundles suitable for implementing monitoring, detection, signalling, display and control in apparatus of the kind described. Current widely-used and suitable protocols include PROFIBUS and HART.

The control processor may itself be connected directly or indirectly to a distributed control system of a manufacturing or research installation, for centralised monitoring and/or control.

Where respective inclinometers are provided on more than one component of the column, such as on a column tube and on one or more discrete end components thereof such as a fixed end plate, end cap or end flange, these can be used to verify that the components are properly mutually orthogonal.

A further implementation is in relation to a column comprising a column piston, being a column component which fits sealingly into the column tube, usually providing an end cell of the column's working volume with a fluid inlet or outlet conduit. The skilled person is well aware that even very slight angling or tilting of the piston axis away from the column axis can cause serious problems, depending on the type of column. The piston may become stuck or wedged. The seals of the piston or the adjacent tube interior may be damaged. And if a sliding piston although sealing is not exactly perpendicular, it may cause a relatively greater compression at one side of a particle bed than at the opposite side, or a lack of full symmetry in the flow space. These non-uniformities can seriously affect the yield or resolution of separation in the separation or chromatography process.

Accordingly, one particular proposal herein is to provide an inclinometer fixed on or fixable on an end cell piston (column piston) of the chromatography column. Again, the piston may have a reference mounting such as a flat reference surface against which the inclinometer is fixed or fixable. This is desirably a surface normal to the piston's axial direction or to a radial direction thereof, or lying in a radial plane, on which or against which the inclinometer is fixed or can be fixed. It may be a surface of a main piston body, e.g. a machined surface. Or, a mounting piece for mounting the inclinometer may be fixed onto the piston body, e.g. by welding or by threaded fasteners. The reference mounting may include mounting means such as fasteners, or formations such as threaded holes for receiving fasteners, to mount the inclinometer(s).

Where a piston-mounted inclinometer provides an output signal, this may be used for controlling alignment of the piston. The inclinometer may be connected to communicate with a control processor and/or other data processor in any of the ways already set forth above. The control processor may be programmed to operate a support and/or drive mechanism for the piston, for example a set of power-driven supports distributed around the piston and operated by e.g. screw-thread, pneumatic or hydraulic drive mechanisms which are operable to drive the piston axially relative to the column or support structure thereof. The program and system may incorporate a feedback or servo element to keep the piston level as it is moved. It is known to control the drives of individual drive cylinders connected to different parts of a piston to keep it perpendicular to the column. Conventionally this is done by means of a set of vertical resistance wires spaced around the column, but these are unreliable and insensitive. By contrast an inclinometer on the piston offers a very sensitive detection of actual orientation which can be directly used for drive control.

A piston-mounted inclinometer output may be compared with a column tube-mounted inclinometer output to check relative alignment.

The inclinometer may comprise or be connected to a display which is carried on the column or its support structure, or is separately mounted e.g. on a skid.

A control processor and/or display as described for any of the above purposes may be carried on the same support structure as the column, e.g. on a support frame or upper part thereof. Or, one or more of these components may conveniently be carried on a mobile skid that conventionally accompanies a chromatography column and carries the pump etc. and other power and fluid controls to operate it.

A further aspect of the invention is a method of operating any column having an inclinometer as defined herein, including determining the orientation or alignment of the column or a component thereof using the respective inclinometer. The method may include levelling the column or component thereof, e.g. piston, in dependence on output from the inclinometer, such as by means of automatic control using a programmed controller to operate a support adjustment mechanism for the column or for the component thereof such as a piston. Or, inclinometer output such as display output may be used by an operator for manual or part-manual operation of the support structure adjustment mechanism.

Such a method may be used in the preparation of a column for operation, and/or for monitoring its status during operation.

As mentioned, in the method the control processor or control system may do any one or more of:

operating an adjustable support structure for the column, or a support/drive structure for a mobile component (such as a column end piston), to adjust its orientation in dependence on the output signal from the inclinometer;

indicating a levelling adjustment needed for levelling the column/component and/or how to make such adjustment;

giving an alarm or warning in the event of a change of the detected inclination;

giving an alarm or warning in the event that the detected inclination exceeds a predetermined deviation from the horizontal (or any other desired orientation);

recording or logging the orientation over a period e.g. for monitoring or process validation reasons, or

any combination of these or other functions.

The monitoring, recording, alarm and warning functions are useful e.g. where there is a possibility of disturbance of the column, such as by accidental impacts or by earthquakes. It is important to know whether these have compromised the set-up or processing. A system as proposed herein can readily be incorporated into a monitoring, plant surveillance or other general process management system such as a distributed control system (DCS) comprising a network of controllers.

The specific type of inclinometer is not critical, in that a variety of inclinometer mechanisms are now available in a form enabling them to be fixed to a chromatography column in the manner described and especially to provide a two-axis reading.

Single-axis inclinometers may be provided reading along different axes, but two-axis inclinometer units are readily available and are therefore preferred. Electronic inclinometers are preferred. They may incorporate a mechanical or micromechanical element e.g. for generating an artificial horizon, e.g. a gyroscopic component, and this may be incorporated as a MEMS structure. Or, an inclinometer based on another physical phenomenon such as a light beam, a change in capacitance, or a magnet element, may be used according to the knowledge of the skilled person. These devices have the advantage that they can provide a quantitative signal which can be used then for process control. The process control can be much more efficient in iteration than the conventional manual methods. In this, as in providing direct 2-axis (X-Y) monitoring, they provide a radical advantage over the conventional use of manual spirit levels. While these benefits of digital inclinometer technology are known in themselves, the specific advantages that they can offer to chromatography columns and separation processes in columns have not previously been appreciated.

Desirably the inclinometer discriminates down to at least 0.5°, preferably down to 0.2° or 0.1° or finer. The inventor has noticed that for example with an expanded bed adsorption process, even a 0.5° misalignment of the column axis relative to the vertical led to a significant decrease in separation effectiveness. A suitable inclinometer is easily and economically available because the range of measurable angle need not be large, usually not more than ±10°, not more than ±5° or even less.

A preferred inclinometer is provided as a device comprising a solid housing with a flat datum surface and a fixing formation, such as one or more flanges with fastener holes, for fixing it with the datum surface against a corresponding reference surface of the column.

### BRIEF DESCRIPTION OF THE DRAWINGS

Examples of chromatography columns and processes embodying our proposals are now described, with reference to the accompanying drawings in which:

FIG. 1 is a schematic perspective view showing a packed-bed industrial chromatography column.

FIG. 2 is an axial cross section of an industrial expanded bed adsorption (EBA) colum.

FIG. 3 is a fragmentary detail of FIG. 2.

### DESCRIPTION OF THE SELECTED EMBODIMENTS

For the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates. One embodiment of the invention is shown in great detail, although it will be apparent to those skilled in the relevant art that some features that are not relevant to the present invention may not be shown for the sake of clarity.

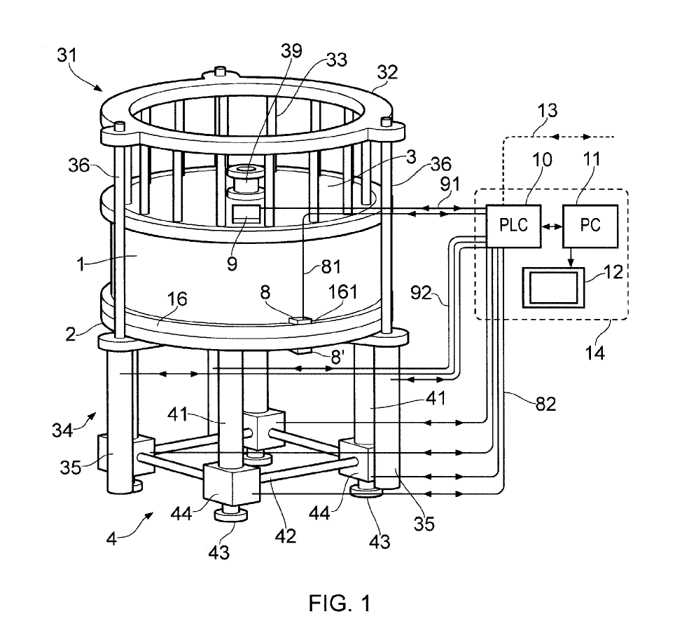

With reference to FIG. 1, a large-scale packed bed chromatography column has a steel column tube 1 mounted axially vertically on a support structure 4 which supports a base 2 of the column on which the column tube 1 rests at its lower end. Other column materials e.g. glass or plastics such as acrylic, may be used. The top of the column tube is closed by a movable top piston 3 suspended by support rods 33 from a support ring 32 spaced above the column tube 1. A piston drive mechanism indicated generally at 34 is provided in this embodiment by a set of three vertically-acting hydraulic drive cylinders 35 mounted equidistantly around the column, fixed to the base 2, and having respective drive rods 36 which reach up to the piston support ring 32. Together, these elements constitute a piston support structure 31. For simplicity, some guide structures for the drive rods and piston support have been omitted.

The stand 4 consists of a set of upright legs 41 each with a respective foot 43 connected to the fixed leg 41 through a driveable adjuster mechanism 44, indicated schematically. The drivable adjuster mechanisms incorporate for example servo motors driving a screw-threaded connection to adjust the axial projection of each foot 43 relative to its fixed leg 41. Cross braces 42 between the legs 41 provide rigidity of the support structure 4.

Again, for simplicity the power supplies to the drivable foot adjusters 44 and the power and hydraulic supplies for the piston drive cylinders 35 are omitted from the figure but are provided in accordance with normal practice. By a conventional communications protocol, the foot adjusters 44 and the piston drive cylinders 35 are automatically controllable from a control processor such as a programmable logic controller (PLC) 10 indicated schematically in FIG. 1, connected to a suitable user interface such as a PC 11 with video display 12 (e.g. LED, LCD or standard monitor) also shown schematically in FIG. 1. An optional connection 13 to a distributed control system is indicated schematically.

In practice the controller 10 and interface 11,12 are preferably mounted on a separate mobile skid. Skids are conventionally used with industrial chromatography columns so the details are not critical and the skid 14 is indicated here only schematically.

The structure of the column, base, piston and supports is generally primarily of stainless steel and may be of great size, e.g. up to two metres or more in diameter, and weight. As is well known, in practice a packed bed of particulate chromatography medium is established in the internal volume of the column beneath the piston 3 and process liquid is passed through from an inlet structure 39—typically in the centre of the top piston 3 as indicated generally—to an outlet typically in the base (not shown). During establishment of the packed bed it is necessary to move the piston 3 axially relative to the column tube, with peripheral seals thereof making sliding contact, using the hydraulic drive cylinders 35 to control and guide the movement. For this, it is important that the cylinders work accurately in concert to ensure that the piston 3 remains accurately perpendicular to the column tube axis. Even slight non-perpendicularity can cause a spoiled pack of the column, leading to great waste of time and sometimes even damage to the piston seals or other problems.

For operation of the column, it also is of critical importance that it is axially vertical so that fluid flow (influenced by gravity) is accurately axial, and that the column tube 1 is accurately perpendicular to the base 2 and piston 3 as mentioned.

Thus, as a skilled person knows, packing normally includes a stage of filling a slurry into the bed space, flow packing to expel all air and compact the bed at the bottom of the space by flowing liquid down through it with the piston in a raised position, and then lowering the piston gradually onto the top of the bed. Especially in this latter stage piston alignment is critical.

A column inclinometer 8, that is to say, an inclinometer for determining the orientation of the column tube 1 relative to the vertical, is mounted on a reference surface of the column tube which is machined to be precisely perpendicular to the column tube axis. In the illustrated embodiment this reference surface is an upward surface 161 of a bottom flange 16 of the column tube 1. Additionally or alternatively, a column inclinometer could be positioned on the top flange, or mounted on a separate formation projecting from the column wall, and/or on a formation integral with the base plate or indeed the support structure 4. For example 8′ indicates schematically an alternative inclinometer position on the underside of the base plate 2. The inclinometer is a 2-axis electronic inclinometer able to detect and signal variations relative to the vertical down to 0.01°. It has a signal output line 81, such as an ethernet cable, connecting to the controller 10.

A piston inclinometer 9, that is to say an inclinometer mounted to determine the orientation of the piston axis relative to the vertical, is mounted on a reference surface on top of the piston, being a surface portion of the piston machined to be precisely perpendicular to the piston axis. As for the column, a 2-axis inclinometer is used and has a signal output line 91 to the programmed controller 10. The controller 10 is connected to control operation of the piston support and drive mechanism 34 through piston control signal lines 92 (indicated schematically) and operation of the drivable foot adjusters 44 individually by support control signal lines 82, also indicated schematically. These control lines 82,92 are installed in accordance with the relevant communication protocol, and may be for example cables using 4-20 mA signals for controlling the relevant servo motors, stepper motors, hydraulic or pneumatic pumps or whichever other drive and control mechanisms are used in the system.

The controller 10 is programmed to maintain perpendicularity/horizontality of the column tube 1 and piston 3 by means of a control program which in itself may use known program elements. Thus for example, the column inclinometer 8 continuously reports to the controller 10 and any non-perpendicularity is processed by a levelling algorithm to determine appropriate movements of one or more of the feet 43 to level the column. Corresponding signals are then sent by the control lines 82 to trigger appropriate driving of the relevant foot/feet 43. Preferably a closed loop or servo feedback is applied, in which the ongoing signals from the inclinometer are used to confirm that perpendicularity/horizontality is achieved or restored by the adjustment.

A similar control scheme may be used in relation to control of the movement of the piston 3, at least when it is being moved, using signals from the piston inclinometer 9 which, processed by the relevant levelling control algorithm in the controller 10, are used to control the three hydraulic cylinders 35 with appropriate feedback to keep the piston level as it moves.

The skilled person will appreciate that the sensing of horizontality by the inclinometers 8,9 is significant not only at the time of adjustment, but also during operation of the column if for example there is any possible disturbance to the apparatus such as by an impact or an earthquake. For this case the system may be programmed to signal a warning or alarm. In any event, the system is preferably programmed to record the alignment/orientation history of the column 1 and/or the piston 3 during set-up and/or during of the chromatography process.

According to normal practice, use of a PLC is preferred for direct control, being simple and highly reliable. The PC 11 is out of the direct line of control and used for adjustment, program modification, input and monitoring. The skilled person is aware of other available programmable control arrangements which may be used.

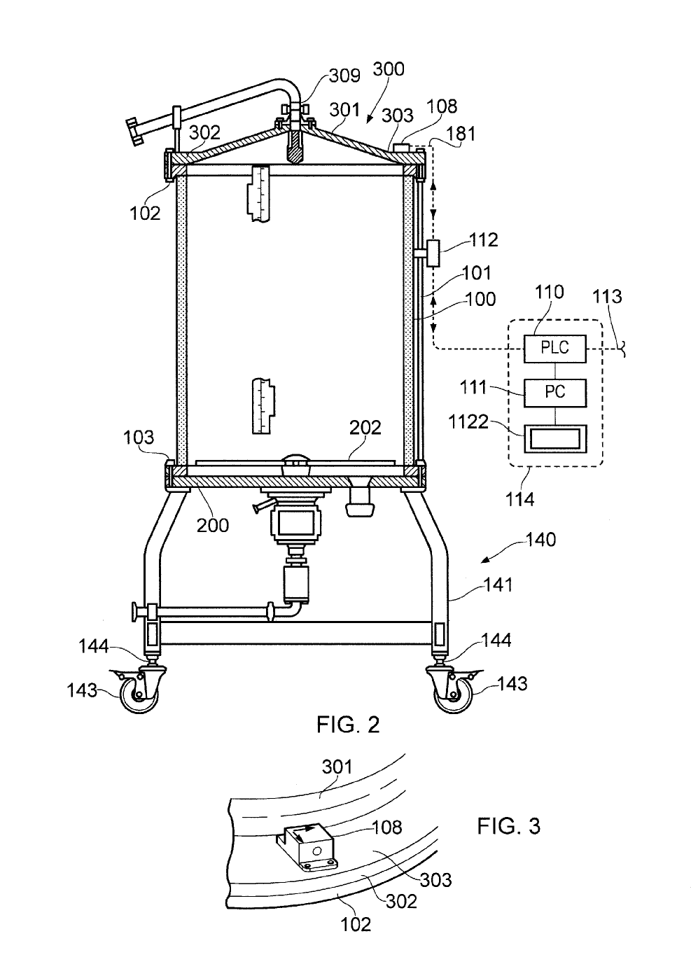

FIG. 2 illustrates an inclinometer on an EBA column which in this embodiment is of a kind described in our recently-filed EP16161264.3 and equivalents in other countries, claiming the priority of GB1504695.6, the entire contents of which are incorporated herein by reference. However many of the features relevant for the present purpose are common to other EBA columns. The column comprises a column tube 100, e.g. of acrylic, mounted vertically between top and bottom clamping rings 102,103 which seal respectively to a top cover 300 and a base plate 200. A set of circumferentially-spaced tie rods 101 clamps these components together axially. The base 200 is mounted fixedly on a stand 140 comprising four rigid legs 141 each with a roller foot 143 at its bottom end. Each roller 143 is connected to the respective leg 141 by an adjustable screw thread mechanism 144 which is adjustable manually for levelling the column.

FIG. 2 also shows an inlet structure 202 at the base 200 and an outlet structure 309 in the top cover 300. These are not particularly relevant to the operation of the inclinometer, and so are not discussed further. The top cover 300 has a central conical portion 301 and a peripheral flange 302. A 2-axis inclinometer 108 is mounted on a top surface 303 of the peripheral flange which is very accurately perpendicular to the top cover axis. The whole top surface 303 may be accurately perpendicular, or, if preferred, a portion thereof may be machined for this purpose. As an alternative, a perpendicular platform for the inclinometer may be provided (e.g. machined integrally with the top cover 300 or welded thereto) closer to the centre.

As known, EBA columns generally have an open top or top piston rather than a fixed top, in which case the top

The inclinometer 108 has a signal output line 181 shown schematically, and communicating to a display 112, conveniently mounted to one of the tie rods 101 of the column tube. The display may alternatively be mounted to the top ring 102 or cover 300 of the column, to be nearer (standing) eye level, or to the stand 140 to be nearer eye level for a person adjusting the stand. The inclinometer 108 is also connected to a programmable logic controller 110 and as in the first embodiment this can conveniently be mounted on an associated skid 114 indicated schematically, and carrying a display 1122, PC 111 and DCS connection 113. Further connections to external devices may be provided if wished.

Vertical orientation of the column tube is of great importance in expanded bed adsorption to ensure uniform flow through the expanded particle bed. By provision of the inclinometer 108, this verticality can be assured when setting up the column, and monitored during operation of the column. In this embodiment the adjustment of the support structure 140 is manual, but can be assisted by the logic controller 110 on the skid 114. The display 112 may simply indicate the detected inclinations in the x and y directions of the column. These readily indicate to the user whether the column is level or not. The controller may be programmed with a control or levelling algorithm to indicate to a user which feet 143 need to be adjusted to level the column while maintaining stability: this is notoriously difficult when done by trial and error. Incidentally, it may be noted that the conical top of the column in this special example, advantageous for separate reasons, would make the conventional use of a spirit level difficult.

While the invention has been illustrated and described in detail in the drawings and foregoing description, the same is to be considered as illustrative and not restrictive in character, it being understood that only the preferred embodiment has been shown and described and that all changes, equivalents, and modifications that come within the spirit of the inventions defined by following claims are desired to be protected. All publications, patents, and patent applications cited in this specification are herein incorporated by reference as if each individual publication, patent, or patent application were specifically and individually indicated to be incorporated by reference and set forth in its entirety herein.

1. A chromatography apparatus comprising:
a chromatography column, said column comprising additionally at least one inclinometer for measuring the orientation of the column, or of one or more components thereof, relative to the horizontal and/or vertical.

2. The chromatography apparatus of claim 1 in which:
a said inclinometer is a two-axis inclinometer, operable and positioned to measure the orientation or inclination of the column or component thereof in respective mutually transverse or perpendicular axes.

3. The chromatography apparatus of claim 1 in which the apparatus comprises first and second inclinometers, operable and positioned to measure the orientation or inclination of the column or component thereof in respective mutually transverse or perpendicular axes.

4. The chromatography apparatus of claim 1 in which the inclinometer is an electronic or electric device operable to produce an electrical output signal.

5. The chromatography apparatus of claim 1 in which the inclinometer is fixedly mounted to a flat reference surface of the column, the reference surface being normal to an axial direction of the column.

6. The chromatography apparatus of claim 1 which further comprises a display to show the inclination or orientation of said column or component from the inclinometer output.

7. The chromatography apparatus of claim 6 in which said display:
is on a said inclinometer;
is carried on the column;
is carried on a support structure of the column; or
is mounted on a separate skid comprised in the apparatus.

8. The chromatography apparatus of claim 1 in which a said inclinometer is:
on a sidewall or end flange of a column tube component of the chromatography column, or
on a fixed top closure or bottom closure end member component of the chromatography column.

9. The chromatography apparatus of claim 1 in which the chromatography column comprises an end cell piston component or column piston component and a column tube component in which said piston component is slidable, and said inclinometer is on the end cell piston component or column piston component.

10. The chromatography apparatus of claim 1 which further comrpises a control processor connected to the output from the inclinometer.

11. The chromatography apparatus of claim 10 in which the control processor comprises a programmable logic controller (PLC).

12. The chromatography apparatus of claim 10 in which the control processor is programmed to perform one or more selected from the following procedures:
operate an adjustable support structure for the column, or a support drive structure for a mobile column component to adjust its orientation in dependence on the output signal from the inclinometer;
indicate a levelling adjustment for levelling the column/component;
give an alarm or warning in the event of a change of a detected inclination;
give an alarm or warning in the event that a detected inclination exceeds a predetermined deviation from the horizontal or other desired orientation; and/or
record or log the orientation over a period.

13. The chromatography apparatus of claim 10 which further comprises an adjustable support structure for the column and wherein the control processor is programmed to operate the adjustable support structure to adjust its orientation in dependence on the output signal from the inclinometer.

14. The chromatography apparatus of claim 13 in which the support structure for the column is a stand having a set of support feet to make respective support contacts distributed around the column to support it stably on a support surface, and comprises levelling adjustment mechanism for adjusting the relative axial positions of the respective support contacts.

15. The chromatography apparatus of claim 14 in which the levelling adjustment mechanism comprises a power drive for the adjusting mechanism.

16. The chromatography apparatus of claim 1 having one or more selected from the following features:
the chromatography column components include an end cell piston or column piston slidable in a column tube, and a said inclinometer is on the end cell piston;
the apparatus comprises a support and/or drive mechanism for the piston comprising a set of power-driven supports distributed around the piston and operable to drive the piston axially relative to the column;
the apparatus comprises a control processor connected to the output from the inclinometer on the end cell piston; and
the control processor is programmed to operate the support and/or drive mechanism for the piston, in dependence on the output from the inclinometer to keep the piston level as it is moved.

17. A method of operating a chromatography apparatus according to claim 1, comprising the step of determining the orientation or alignment of the column or a component thereof using the respective inclinometer.

18. The method according to claim 17 comprising levelling the column or component thereof in dependence on output from the inclinometer, by means of automatic control using a programmed controller to operate a support adjustment mechanism for the column or for the component thereof.

19. The method according to claim 17 comprising one or more selected from the following procedures:
operating an adjustable support structure for the column, or a support/drive structure for a mobile component such as a column end piston, to adjust its orientation in dependence on the output signal from the inclinometer;
indicating a levelling adjustment needed for levelling the column/component or how to make such adjustment;
giving an alarm or warning in the event of a change of the detected inclination;
giving an alarm or warning in the event that the detected inclination exceeds a predetermined deviation from the horizontal or other desired orientation; and/or
recording or logging the orientation over a period.
